(19) United States
(12) Patent Application Publication
(10) Pub. No.: US 2026/0052607 A1
(43) Pub. Date: Feb. 19, 2026

(54) COVER FOR INDUCTIVE HEATING COOKER AND INDUCTIVE HEATING COOKER HAVING SAME

(71) Applicant: LG Electronics Inc., Seoul (KR)

(72) Inventors: Yeon A JO, Seoul (KR); Byunghoon Park, Seoul (KR); Sungpil Kim, Seoul (KR); Byung Soo Oh, Seoul (KR); Min Kyu Oh, Seoul (KR); Hanjin Jung, Seoul (KR); Sungkyung Kim, Seoul (KR)

(21) Appl. No.: 19/063,179

(22) Filed: Feb. 25, 2025

(30) Foreign Application Priority Data
Aug. 19, 2024 (KR) 10-2024-0110719

(51) Int. Cl. H05B 6/12; B32B 3/30; B32B 7/023; B32B 7/027; B32B 15/06; B32B 15/20; B32B 25/20; G01K 11/12; H05B 3/74; H05B 6/10

(52) U.S. Cl. CPC H05B 6/1209; B32B 3/30; B32B 7/023; B32B 7/027; B32B 15/06; B32B 15/20; B32B 25/20; G01K 11/12; H05B 3/74; H05B 6/105; B32B 2307/302; B32B 2307/4026; B32B 2307/414

(57) ABSTRACT

Provided is a cover for an inductive heating cooker including a top plate provided with at least one crater, on which a cooking container is placed, and a working coil arranged on one side of each of the at least one crater of the top plate to inductively heat the cooking container. The cover includes a cover body interposed between the at least one crater of the top plate of the inductive heating cooker and the cooking container, and a high-temperature display part including a thermochromic layer made of thermochromic material and arranged on one side of the cover body, the thermochromic layer changing a color thereof to a first color below a predetermined temperature and to a second color, different from the first color, at at least the predetermined temperature.

### CROSS-REFERENCE TO RELATED APPLICATION

Pursuant to 35 U.S. C. § 119(a), this application claims the benefit of the earlier filing date and the right of priority to Korean Patent Application No. 10-2024-0110719, filed on Aug. 19, 2024, the contents of which are incorporated by reference herein in their entirety.

### BACKGROUND

### Field

The disclosure relates to a cover for an inductive heating cooker with a structure that facilitates a user's visual recognition of the risk of burns and to an inductive heating cooker having the same.

### Description of the Related Art

In recent years, the spread of inductive heating cookers that cook using induction heating has been increasing.

An inductive heating cooker is a device that cooks by utilizing the principle that an eddy current is induced on a cooking container having magnetism by using a magnetic field, which is generated around a coil when a high-frequency power of a certain magnitude is applied to the coil, and the cooking container is heated using the eddy current.

The inductive heating cooker may include a housing having a top plate mainly made of tempered glass, a coil accommodated in the housing to be adjacent to a lower surface of the top plate, a component, such as a power module, for actuating the coil, and a component, such as a control module, for controlling operations of various components including the coil.

In some examples, a protective cover may be interposed between the top plate of the inductive heating cooker and the cooking container placed on the top plate. The protective cover may usually be made of heat-resistant silicone rubber to suppress slippage of the cover itself on the top plate and slippage of the cooking container on the cover and withstand high heat of the cooking container. Using a cover may suppress contamination or malfunction of an inductive heating cooker by blocking food, which overflows a cooking container during cooking, from directly contacting the inductive heating cooker, and may also suppress damage due to external impact, overheating due to heat transmitted from the cooking container, and malfunction caused by the overheating.

The cover may reach even temperatures high enough to cause a user's burn due to heat, which is generated from the cooking container heated during cooking. However, until now, there has been no way for the user to check how hot a cover is, leaving the user at risk of thermal burns from contact with the hot cover during or, especially, after cooking.

The cover may moreover be thermally damaged by high temperature of the cooking container when the cover is thin.

Accordingly, there is a need to develop a structure that enables users to check whether a cover for an inductive heating cooker is hot to suppress thermal burns caused by the cover.

Additionally, an inductive heating cooker may include a temperature sensor that detects the temperature of a cooking container through a top plate to perform an overheating suppression function or detects the temperature of the top plate to suppress the risk of thermal burns due to residual heat of the top plate after cooking is finished. Information related to the temperature of the top plate of the cooking container detected by the temperature sensor or the risk of thermal burns based on the detected temperature may be displayed on an interface part which displays information related to the status of the inductive heating cooker.

However, when a protective cover is interposed between the cooking container and the top plate of the inductive heating cooker, the thermal conductivity (approximately 1.00 W/(m K)) of silicone rubber, which is the material of the cover, is low, corresponding to about 1/5 of the thermal conductivity (approximately 1.00 W/(m K)) of tempered glass, which is the material of the top plate, making it impossible to accurately detect the temperature of the cooking container or the cover using the temperature sensor installed below the top plate. Accordingly, the overheating suppression function of the inductive heating cooker may not be performed properly, which may cause overheating of the container and the risk of fire due to the overheating, or leave the user at risk of thermal burns from residual heat of the cover.

Patent Document 1 (Korean Patent Application No. 10-2023-0166286) discloses a cover for an inductive heating cooker that is capable of directly detecting heat generated from a cooking container by itself and notifying a result of the detection to the inductive heating cooker through communication.

However, Patent Document 1 has a complex configuration because various components for temperature detection, communication, and charging must be embedded in the cover. In addition, Patent Document 1 does not provide a function to notify a user of the risk of burns due to residual heat of the cover, especially after cooking is finished.

Accordingly, there is also a demand for the development of a structure that enables a direct detection of the temperature of the cooking container in the inductive heating cooker, despite the presence of the cover, without using the cover having the complex configuration.

In some examples, in addition to the protective cover described above, a heating cover is also known. A heating cover is a circular plate made of magnetic material and is arranged between the top plate of the inductive heating cooker and a non-magnetic cooking container. The heating cover made of the magnetic material is inductively heated by itself and transfer heat to the non-magnetic cooking container, to allow for cooking using the non-magnetic cooking container on the inductive heating cooker. The heating cover is also called an adapter plate, hot plate, or heat conducting plate.

The heating cover, like the protective cover, may also reach a temperature that may cause the user's burn. In some examples, the heating cover itself is heated to high temperature, so the risk of burns is further increasing. Therefore, even for the heating cover, it is necessary to facilitate the user to check the risk of burns due to high temperature.

### SUMMARY

The disclosure has been derived to solve the above problems, and an aspect of the disclosure is to provide a cover for an inductive heating cooker having a structure capable of visually notifying a user of the risk of burns.

Another aspect of the disclosure is to provide a cover for an inductive heating cooker that is capable of visually notifying a user of the risk of burns with a simple and inexpensive structure.

Still another aspect of the disclosure is to provide a cover for an inductive heating cooker having a structure that enables the inductive heating cooker to accurately detect the temperature of a cooking container during cooking.

Still another aspect of the disclosure is to provide an inductive heating cooker having the cover described above.

To achieve those aspects and other advantages according to one or more embodiments, there is provided a cover for an inductive heating cooker including a top plate provided with at least one crater, on which a cooking container is placed, and a working coil arranged below each of the at least one crater of the top plate to inductively heat the cooking container. The cover may include a cover body interposed between the at least one crater of the top plate of the inductive heating cooker and the cooking container, and a high-temperature display part including a thermochromic layer made of thermochromic material and arranged on one side of the cover body, the thermochromic layer changing a color thereof to a first color below a predetermined temperature and to a second color, different from the first color, at at least the predetermined temperature.

This may facilitate a user to visually check whether the cover is hot, thereby reducing the risk of burns due to high temperature.

According to an embodiment, the thermochromic layer of the high-temperature display part may be arranged on a lower surface of the cover body, and the cover body may be made of silicone rubber material and may be transparent or translucent, or may include a display groove which externally exposes at least a portion of the thermochromic layer. Accordingly, the color change of the thermochromic layer may be easily checked while suppressing the thermochromic layer from being damaged by the cooking container or soup that may overflow the cooking container.

The at least the portion of the thermochromic layer of the high-temperature display part may be located outside a maximum diameter of the cooking container to be placed on the at least one crater.

This may facilitate the color change of the thermochromic layer during cooking to be checked without being obstructed by the cooking container.

In some embodiments, the high-temperature display part may further include a thermal conductive layer configured to transfer heat generated from the cooking container to the thermochromic layer.

The thermal conductive layer may be made of non-magnetic metal material including copper or aluminum.

The thermal conductive layer may allow heat generated from the cooking container to be quickly transferred to the entire thermochromic layer, such that the thermochromic layer may evenly change its color, thereby allowing the user to more accurately recognize whether the cooking container is at high temperature.

In an embodiment, the thermochromic layer may be formed by printing the thermochromic material on the lower surface of the cover body, and the thermal conductive layer may be formed by printing non-magnetic metal powder on the lower surface of the cover body.

By printing the thermochromic layer and the thermal conductive layer, the manufacturing process of the cover may be simplified.

In some embodiments, the high-temperature display part may further include a protective layer covering the lower surface of the cover body.

This may eliminate the user's unfamiliar feeling caused by metallic luster of the metal powder of the thermal conductive layer and also suppress the occurrence of scratches on the top plate caused by the metal powder.

In another example, the cover body may be made of transparent or translucent silicone rubber material, and the high-temperature display part may be formed by mixing the thermochromic material and non-magnetic metal powder with a raw material of the cover body and integrally molding the mixture with the cover body.

This may simplify the manufacturing process of the cover and reduce processing steps.

The cover body may include a heat transfer pin vertically penetrating the cover body at a portion corresponding to a center of each of the at least one crater.

Accordingly, a temperature sensor of the inductive heating cooker for detecting the temperature of the cooking container to suppress overheating may accurately detect the temperature of the cooking container through the heat transfer pin, even though the temperature sensor is spaced apart from the cooking container due to the cover.

The thermochromic material may be a thermosensitive pigment.

In some embodiments, the predetermined temperature may range from 40° C. to 60° C.

The first color may be transparent and the second color may be colored, or both the first color and the second color may be colored.

The cover body may be configured to cover the entire top plate of the inductive heating cooker, and the high-temperature display part may be arranged on a portion corresponding to each of the at least one crater of the cover body.

Accordingly, the entire top plate of the inductive heating cooker may be protected by the cover, and a sense of unity between the cover and the inductive heating cooker may be provided.

In some embodiments, the thermochromic layer may have a circular shape, a ring shape, a cross shape, a rectangular shape, or a combined shape thereof, and a diameter or length of the thermochromic layer may be larger than the maximum diameter of the cooking container placed on the at least one crater. The cover body may be formed in a circular shape having a diameter larger than the maximum diameter of the cooking container to be placed on the at least one crater.

This type of cover may be used commonly on different types of inductive heating cookers.

The thermochromic layer of the high-temperature display part may be formed in a circular or arcuate shape along an outer periphery of the cover body.

The cover body may further include a soup overflow suppression bump formed in a ring shape and extending upward from an outer periphery of the cover body.

The soup overflow suppression bump may suppress soup from overflowing the cooking container onto the top plate of the inductive heating cooker.

The cover body may include a pair of handles extending from opposite ends on an outer periphery of the cover body to a radial outside of the cover body.

The user may easily place the cover on or remove the cover from the top plate of the inductive heating cooker by using the pair of handles.

The cover body may include a display panel extending from one side on an outer periphery of the cover body to a radial outside of the cover body, and the thermochromic layer of the high-temperature display part may be formed on the display panel.

Accordingly, the color change of the thermochromic layer during cooking may be more easily checked without being obstructed by the cooking container, and a cover of the cooking container may be suppressed from being formed excessively large relative to a size of the cooking container.

The cover for the inductive heating cooker according to the disclosure may further include a heating plate made of magnetic material placed on the cover body.

Accordingly, cooking may be performed using a cooking container made of non-magnetic material on the inductive heating cooker having the cover.

An inductive heating cooker according to the disclosure may include a top plate including at least one crater on which a cooking container is placed, a working coil arranged on one side of each of the at least one crater of the top plate to inductively heat the cooking container, and the cover described above interposed between the at least one crater of the top plate and the cooking container.

### BRIEF DESCRIPTION OF THE DRAWINGS

The above and other aspects, features and other advantages of the disclosure will be more clearly understood from the following detailed description taken in conjunction with the accompanying drawings, in which:

FIG. 1 is a perspective view of a cover and an inductive heating cooker having the same according to one embodiment;

FIG. 2 is a plan view of the cover of FIG. 1;

FIG. 3 is a cross-sectional view taken along line A-A of FIG. 2;

FIG. 4 is a view of a state of a cover according to an embodiment immediately after an operation of an inductive heating cooker is completed;

FIGS. 5A to 5C are views illustrating color changes of a thermochromic layer according to temperature changes of a cover after removing a cooking container in FIG. 4;

FIG. 6 is a plan view of a modified example of the cover of FIG. 1;

FIG. 7 is a plan view of another modified example of the cover of FIG. 1;

FIG. 8 is a perspective view of a cover according to another embodiment.

FIG. 9 is a perspective view of a cover according to still another embodiment;

FIG. 10 is an exploded perspective view of the cover of FIG. 9; and

FIG. 11 is a cross-sectional view of the cover of FIG. 9.

### DETAILED DESCRIPTION OF THE EMBODIMENTS

Hereinafter, a description will be given in more detail of an inductive heating cooker and a cover therefor according to the disclosure, with reference to the accompanying drawings.

For the sake of brief description with reference to the drawings, the same or equivalent components may be assigned the same or similar reference numbers, and a redundant description thereof will be omitted.

In addition, a structure that is applied to one embodiment will be equally applied to another embodiment as long as there is no structural and functional contradiction in the different embodiments.

A singular representation may include a plural representation unless it represents a definitely different meaning from the context.

In describing the present disclosure, if a detailed explanation for a related known function or construction is considered to unnecessarily divert the gist of the present disclosure, such explanation has been omitted but would be understood by those skilled in the art.

The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

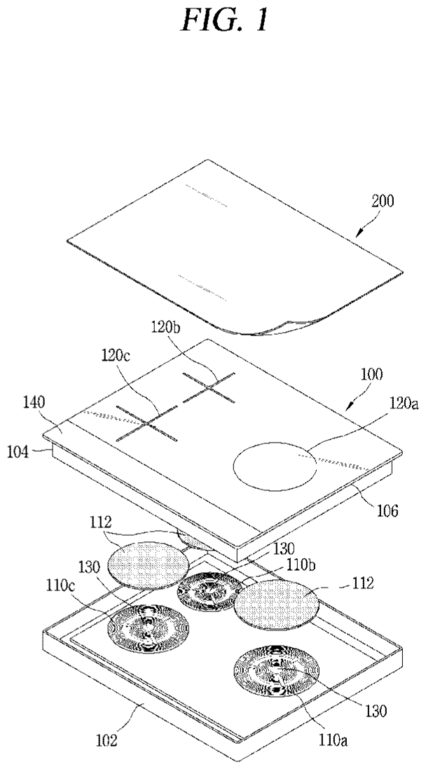

FIG. 1 is a perspective view of an inductive heating cooker 100 and a cover 200 included in the inductive heating cooker 100 according to an embodiment.

The inductive heating cooker 100 may include a case 102 forming a main body, and a top plate part 104 coupled to the top of the case 102 to seal the case 102.

The case 102 may have a hexahedral shape with the top open, and a working coil 110 for heating a cooking container may be arranged in the case 102. Although three working coils 110a, 110b, and 110c are illustrated in FIG. 1, the number of working coils 110 used in the inductive heating cooker 100 may not be necessarily limited to this, and may be, for example, one, two, or four. If necessary, an insulating sheet 112 may also be arranged on the working coil 110 to protect the working coil 110 from heat generated from the cooking container.

In some examples, various components associated with the operation and control of the working coil 110, such as a power supply unit and a control board, may be arranged inside the case 102.

The top plate part 104 may include a top plate 106 on which a cooking container 10 (see FIG. 3) for cooking food may be placed. The top plate 106 may be made of reinforced glass material such as ceramic glass.

The cooking container 10 may be placed on one of heating regions corresponding to the three working coils 110a, 110b, and 110c, i.e., a first crater 120a to a third crater 120c. Lines or figures indicating the craters 120a, 120b, and 120c may be printed on the top plate 106 or may be indicated in other ways, such that a user clearly recognizes the positions of the craters 120a, 120b, and 120c.

A temperature sensor 130 may be arranged on the center of each working coil 110. The temperature sensor 130 may be arranged directly below the top plate 106 to detect the temperature of the cooking container 10, and the control board may perform an overheating suppression function based on the temperature of the cooking container 10 detected by the temperature sensor 130. The temperature sensor 130 may be, for example, a thermistor having a variable resistor.

An interface part 140 may be arranged on one side of the top plate 106, for example, a front side of the top plate 106 to display information related to the status of the inductive heating cooker 100 and receive user inputs for operating the inductive heating cooker 100. The interface part 140 may be, for example, a display with a touch panel.

The user may input a command to operate the inductive heating cooker 100 through the interface part 140. For example, the user may apply an input by touching a specific point on the touch panel to select (or set) a desired crater and a power level of a working coil of the corresponding crater. When the user inputs a command through the interface part 140, the control board may determine power and frequency for operating the working coil at the selected (set) power level and operate the working coil based on the determined power and frequency. Information related to the user's input and the operation of the inductive heating cooker 100 according to the input may be displayed on the interface part 140.

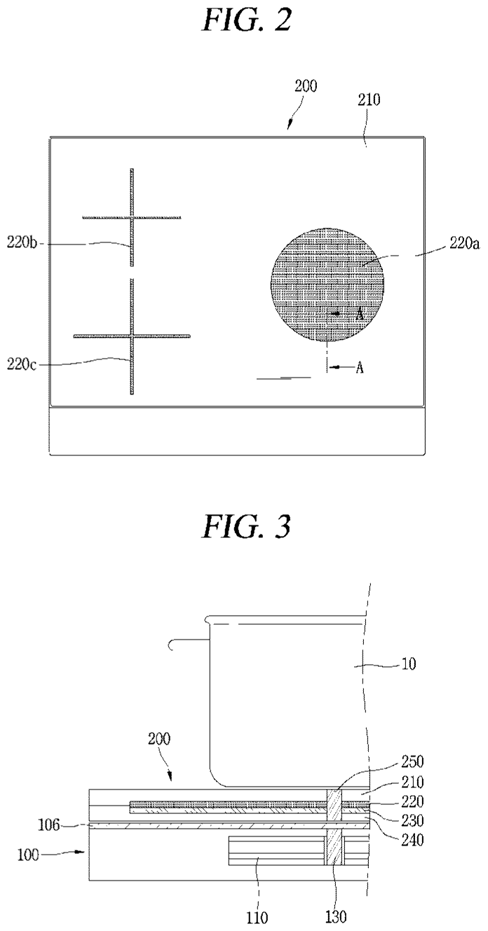

Hereinafter, a cover 200 according to an embodiment will be described. As illustrated in FIG. 1, a cover 200 according to an embodiment may be arranged on the inductive heating cooker 100 to cover the entire top plate 106 of the inductive heating cooker 100. FIG. 2 is a plan view of the cover 200 of FIG. 1. FIG. 3 is a cross-sectional view taken along line A-A of FIG. 2, showing a crater portion of the cover 200 illustrated in FIG. 2 together with a container placed on the cover 200.

The cover 200 illustrated in FIGS. 1 to 3 is an example of a protective cover that suppresses contamination or malfunction of the inductive heating cooker 100 by blocking food, which overflows the cooking container 10 during cooking, from directly contacting the inductive heating cooker 100, and may also suppress damage due to external impact, overheating due to heat transmitted from the cooking container 10, and malfunction caused by the overheating.

As illustrated in FIGS. 2 and 3, the cover 200 according to an embodiment may include a cover body 210 and a high-temperature display part.

The cover body 210 may be made of rubber material with low thermal conductivity and excellent heat resistance. In some embodiments, the cover body 210 may be made of silicone rubber material which is heat-resistant and resistant to deformation caused by hot water and moisture, has a frictional force that may suppress relative slippage with respect to the top plate 106 and the cooking container 10, and is harmless to a human body. In some embodiments, the cover body 210 of the cover 200 according to the illustrated embodiment may be made of transparent or translucent silicone rubber material so that the user may check the position of the crater of the top plate 106 and also check a color development of a thermochromic layer of a high-temperature chromic portion, which is arranged on a lower surface of the cover body 210 as will be described below.

In some embodiments, a line or figure which allows the user to more clearly recognize the position of the crater 120 obscured by the cover body 210 may be marked on an upper surface of the cover body 210. In some embodiments, the line or figure marked on the cover body 210 may be the same as the line or figure marked on the top plate 106 of the inductive heating cooker 100 to indicate the position of the crater 120. The line or figure may be advantageous in view of clearly informing the user of the position of the crater 120 in case where the cover body 210 is made of translucent or opaque material.

In the following description, a region of the cover body 210 corresponding to the crater 120 of the inductive heating cooker 100 may also be referred to as a crater for convenience.

The high-temperature display part may include a thermochromic layer 220, a thermal conductive layer 230, and a protective layer 240.

The thermochromic layer 220 may include a thermochromic material which changes in color due to heat. A thermochromic material may be a material that exhibits a first color below a predetermined temperature and a second color different from the first color above the predetermined temperature, and may also be a thermochromic pigment.

In an embodiment, the predetermined temperature may be the lowest temperature at which the user may suffer a burn or low-temperature burn. For example, the predetermined temperature may be in the range of 40° C. to 60° C.

In an embodiment, the thermochromic pigment may exhibit a transparent color (a first color) below a predetermined temperature (e.g., 40° C.) and a certain color (a second color), for example, a red color above the predetermined temperature.

The thermochromic pigment may be known in the technical field to which the disclosure belongs and may be easily obtained on the market according to desired purposes and characteristics. Therefore, a detailed description of the thermochromic pigment will be omitted here.

The thermochromic layer 220 including the thermochromic pigment, i.e., the thermochromic material, may be arranged on a lower surface of the cover body 210 to be located on the crater 120 on which the cooking container 10 is placed. In some embodiments, the thermochromic layer 220 may be printed on the lower surface of the cover body 210.

The thermochromic layer 220 may have a circular, ring, cross, or rectangular shape, or an arbitrary shape in a combination of these shapes. For reference, FIG. 2 shows, to help understanding, a state in which the thermochromic pigment has developed color, that is, has changed to a second color that is colored because the temperature is above the predetermined temperature. In the example illustrated in FIG. 2, the thermochromic layer 220a is shown to have a circular shape on the first crater 120a on the right, whereas the thermochromic layers 220b and 220c are shown to have a cross (+) shape on the second crater 120b and third crater 120c on the left.

In some embodiments, at least a portion of the thermochromic layer 220 may be formed to be located outside the maximum diameter of the cooking container 10 placed on the crater 120. For example, the circular thermochromic layer 220a formed on the first crater 120a of FIG. 2 may have a diameter larger than the maximum diameter of the cooking container 10 that may be placed on the first crater 120a.

Accordingly, even in the state where the cooking container obscures the crater, the user may easily tell that the cooking container 10 or cover 200 is at a high temperature higher than or equal to a predetermined temperature by viewing the change in color of the thermochromic layer 220 located on the outside of the cooking container 10.

In some embodiments, the cover body 210 may be made of silicone rubber material with low thermal conductivity. Therefore, a color development state may differ due to a difference in thermal conductivity between inner and outer portions of the thermochromic layer 220.

To solve this problem, the thermal conductive layer 230 may be arranged below the thermochromic layer 220. The thermal conductive layer 230 may be formed to have a size which is large enough to cover one inner side of the crater, for example, from the center of the crater to the outermost portion of the thermochromic layer 220.

The thermal conductive layer 230 may include metal powder with excellent thermal conductivity, and may be formed below the thermochromic layer 220 by a printing method, similar to the thermochromic layer 220. When the thermal conductive layer 230 is formed below the thermochromic layer 220 in a manner other than printing, the thermal conductive layer 230 may not need to have the form of metal powder and, for example, may be stacked below the thermochromic layer 220 in the form of a thin metal plate.

To suppress the thermal conductive layer 230 from being inductively heated by the working coil 110, the metal powder forming the thermal conductive layer 230 may be non-magnetic metal powder, for example, copper or aluminum powder.

Heat generated from the cooking container 10 may be quickly transferred to the entire thermochromic layer 220 through the thermal conductive layer 230, and thus the thermochromic layer 220 may be evenly colored throughout.

The protective layer 240 may be arranged below the thermal conductive layer 230. The protective layer 240 may be printed to cover the entire lower surface of the cover body 210, including the thermochromic layer 220 and the thermal conductive layer 230. The protective layer 240 may have an achromatic color which is similar to the color of the thermal conductive layer 230.

The protective layer 240 may be used for the purpose of suppressing the user from feeling unfamiliar due to a metallic luster of the metal powder of the thermal conductive layer 230. The protective layer 240 may also play a role in suppressing scratches on the top plate 106 caused by the metal powder of the thermal conductive layer 230.

In some embodiments, the cover 200 according to an embodiment may include a heat transfer pin 250 positioned in the center of each crater.

As illustrated in FIG. 3, the heat transfer pin 250 may penetrate the cover body 210, the thermochromic layer 220, the thermal conductive layer 230, and the protective layer 240 in an up-and-down (vertical) direction. Accordingly, the upper portion of the heat transfer pin 250 may come into contact with the lower surface of the cooking container 10, and the lower portion of the heat transfer pin 250 may come into contact with the top plate 106 of the inductive heating cooker 100 at a position adjacent to the temperature sensor 130 below the top plate 106.

The heat transfer pin 250 may be made of non-magnetic metal, for example, copper or aluminum, which has high thermal conductivity but is not inductively heated by the working coil 110.

The heat transfer pin 250 may have a cross-sectional shape such as a circular, square, or cross shape.

The cover 200 for the inductive heating cooker 100 having such a configuration according to an embodiment may visually notify the user of the risk of burns by changing the color of the thermochromic layer 220 between a first color and a second color depending on temperature.

Referring again to FIG. 3, the cooking container 10 may be placed on the crater of the cover 200, which covers the top plate 106 of the inductive heating cooker 100. During cooking, the cooking container 10 may be inductively heated by a magnetic field generated from the working coil 110, thereby performing cooking. At the same time, heat of the cooking container 10 may also be transferred even to the cover 200 below the cooking container 10, and thereby, the temperatures of the crater of the cover 200 and the surrounding of the crater may increase.

When the temperature of the thermochromic layer 220 of the cover 200 exceeds a predetermined temperature of approximately 40° C. due to the heat transferred from the cooking container 10, the thermochromic pigment constituting the thermochromic layer 220 may begin to change from a first color, which is transparent, to a second color, for example, a red color, and fully change to the red color when the temperature exceeds approximately 60° C. This may facilitate the user's visual recognition of the risk of burns by viewing that the color of the thermochromic layer 220 has changed to red.

In some examples, the heat transferred from the cooking container 10 through the thermal conductive layer 230 may be quickly transferred up to a portion of the thermochromic layer 220 located on an outer portion of the crater of the cover 200, i.e., outside the cooking container 10. Accordingly, the entire thermochromic layer 220 may be colored evenly by the transferred heat, and the user may more easily determine the risk of burns by viewing the colored portion of the thermochromic layer 220 on the outside of the cooking container 10.

In some embodiments, the heat of the cooking container 10 may be transferred more quickly to the thermochromic layer 220 and the thermal conductive layer 230 through the heat transfer pin 250 which vertically penetrates the cover 200.

Even after cooking is completed, the thermochromic layer 220 may maintain the second color as long as the temperature of the thermochromic layer 220 is maintained at at least a preset temperature due to residual heat of the cover 200. Therefore, the user may easily recognize even the risk of burns due to the residual heat of the cover 200.

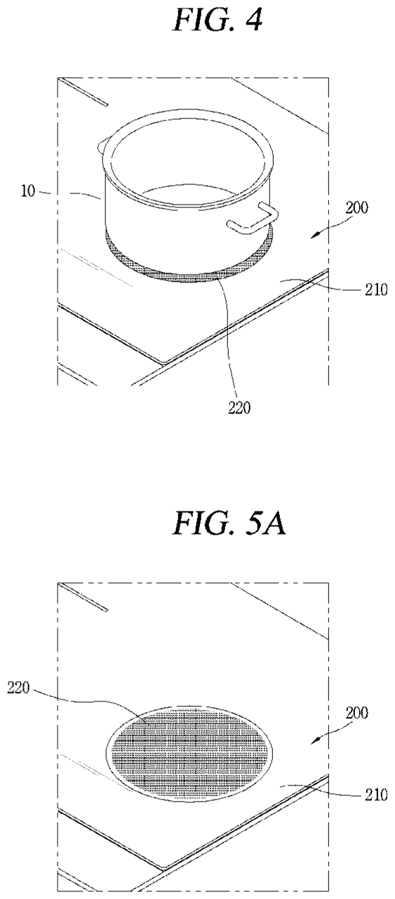

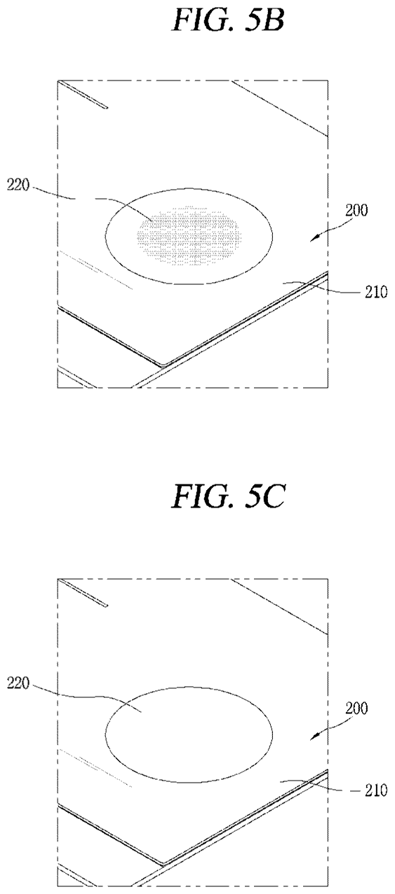

FIGS. 4 and 5A to 5C are views illustrating that the color of the cover 200 changes depending on the change in residual heat of the cover 200 after cooking is completed. In the illustrated example, the thermochromic layer 220 may have an area approximately similar to the area of the cooking container 10.

FIG. 4 is a view of a state immediately after the inductive heating cooker 100 is turned off in the process of heating the cooking container 10, for example, a pot containing water on one of the craters of the cover 200 to boil the water. The color of the thermochromic layer 220 below the pot 10 has changed to the second color, i.e., red, due to the heat of the pot 10 heated by the inductive heating cooker 100. In this instance, the temperature of the pot 10 detected using a contactless thermometer was 113.1° C.

FIG. 5A illustrates a state where the cooking container 10 has been removed from the cover 200 in FIG. 4. In this instance, the temperature of the crater of the cover 200 detected using the contactless thermometer was 96° C. It may be confirmed that the thermochromic layer 220 has been colored in the second color, i.e., red, over the entire crater of the cover 200.

FIG. 5B illustrates a state where the temperature of the crater has dropped to 50° C. over time from the state in FIG. 5A. In FIG. 5B, in which the temperature of the crater is 50° C., the color of the thermochromic layer 220 is maintained with the second color, i.e., red, only on a central portion of the crater, and has changed from the second color to the first color, which is transparent, on a peripheral portion of the crater.

FIG. 5C illustrates a state where the temperature of the crater has dropped to 40°Cover time from the state in FIG. 5B. When the temperature drops to 40° C., the color of the thermochromic layer 220 has changed to the first color, which is transparent, over most of the crater, while the second color, which is red, is rarely visible.

In this way, the user may easily recognize the risk of burns due to the high temperature of the inductive heating cooker 100 during cooking or the residual heat of the cover 200 even after cooking, by checking the color of the thermochromic layer 220 of the cover 200.

In some embodiments, in the state where the cover 200 according to the disclosure covers the top plate 106 of the inductive heating cooker 100, the heat transfer pin 250 of the cover 200 may be aligned with the temperature sensor 130 positioned at the center of the working coil 110 of the inductive heating cooker 100. The cooking container 10 may be placed on the cover 200 during cooking, and its lower surface may come into contact with an upper end of the heat transfer pin 250.

Accordingly, even though the cover 200 according to an embodiment covers the top plate 106 of the inductive heating cooker 100, the temperature of the cooking container 10 may be accurately detected by the temperature sensor 130 of the inductive heating cooker 100 and the heat transfer pin 250, so that an overheating suppression function of the inductive heating cooker 100 may operate properly. In this way, the cover 200 according to an embodiment may suppress the deterioration in safety of the inductive heating cooker 100, unlike related art covers.

Alternatively, in the cover 200 according to the disclosure, the overheating suppression function of the inductive heating cooker 100 may be performed even without using the heat transfer pin 250. That is, the thermal conductive layer 230 for evenly transferring heat from the cooking container 10 to the entire thermochromic layer 220 may be made of the same material as the heat transfer pin 250 and may be arranged on the lower surface of the cover 200. Accordingly, the temperature of the cooking container 10 may be estimated from the temperature of the thermal conductive layer 230 detected by the temperature sensor 130 of the inductive heating cooker 100 based on data known in advance, such as the materials, thicknesses, and thermal conductivities of the cover body 210 and the thermal conductive layer 230, and the overheating suppression function may be performed according to the estimated temperature of the cooking container 10.

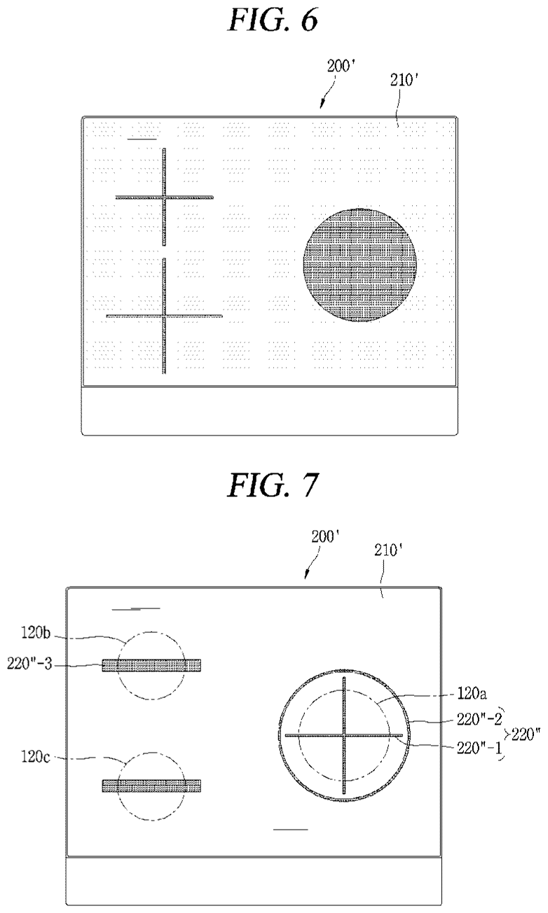

FIG. 6 is a plan view of a modified example 200′ of the cover illustrated in FIGS. 1 to 3. Unlike the cover 200 described with reference to FIGS. 1 to 3, in which the thermochromic layer 220 and the thermal conductive layer 230 are arranged only on the crater of the cover 200, the cover 200′ illustrated in FIG. 6 may be configured such that the thermochromic layer and the thermal conductive layer are arranged over the entire area of the cover 200′.

In this example, in which the thermochromic layer and the thermal conductive layer are arranged over the entire area of the cover 200′, the entire cover 200′ may change to a second color by heat or residual heat transferred from the cooking container to the entire cover 200′ through the thermal conductive layer. The user may more easily check the risk of burns by viewing the changed color of the entire cover 200′. Of course, the crater on which the cooking container is placed and the peripheral area of the crater may have higher temperatures than other areas, and thus may change in color more quickly and clearly than the other areas. This is further emphasized in FIG. 6.

In the example illustrated in FIG. 6, the thermochromic layer and the thermal conductive layer may be printed sequentially on the lower surface of the cover body 210′ as in the previous embodiment. Alternatively, in an example where the thermochromic layer and the thermal conductive layer are arranged over the entire area of the cover 200′, a thermochromic pigment, such as a thermochromic material, and metal powder as a material having high thermal conductivity may be mixed with a silicone raw material, to form the thermochromic layer and the thermal conductive layer integrally with the cover body 210′. In this instance, a process of printing the thermochromic layer and the thermal conductive layer may be omitted, thereby simplifying the manufacturing process of the cover 200′ and reducing processing steps.

FIG. 7 is a plan view of another modified example 200″ of the cover illustrated in FIGS. 1 to 3.

The cover 200″ illustrated in FIG. 7 may differ from the previous examples in that a first color of a thermochromic layer 220″ is colored rather than transparent.

In some examples, the thermochromic layer 220″ of the cover 200″ of FIG. 7 may have a first color, for example, white, below a predetermined temperature, and a second color, for example, red, at at least the predetermined temperature.

In this way, the cover 200″ in which the first color of the thermochromic layer 220″ is colored may be advantageous in case that the top plate 106 of the inductive heating cooker 100 has a dark color.

The first color of the thermochromic layer 220″, which appears below the predetermined temperature, is colored, and accordingly, the cover 200″ of the example illustrated in FIG. 7 may indicate the crater with the thermochromic layer 220″ itself.

In the example illustrated in FIG. 7, the thermochromic layer 220″ on the first crater 120a may have a shape, in which a cross 220″-1 for indicating the center of the first crater 120a is surrounded by a ring 220″-2 having a diameter larger than the maximum diameter of the cooking container 10, and the thermochromic layer 220″ on each of the second crater 120b and the third crater 120c may have a shape of a rectangular bar 220″-3, which passes the center of the corresponding second or third crater 120b or 120c and have a length longer than the maximum diameter of the cooking container 10, which may be placed on the corresponding second crater 120b or third crater 120c.

In this way, the thermochromic layer 220″ itself may indicate the crater on the cover 200″ in which the first color of the thermochromic layer 220″ is colored. This may provide an advantage in that there is no need to display a separate line or figure indicating the crater on the upper surface of the cover body 210″.

FIG. 8 is a perspective view of a cover 300 according to another embodiment.

Unlike the covers 200, 200′, and 200″ described with reference to FIGS. 1 to 7, each of which is configured to cover the entire top plate 106 of the inductive heating cooker 100, the cover 300 illustrated in FIG. 8 may be configured to cover only one of the craters of the inductive heating cooker.

Referring to FIG. 8, the cover 300 may include a high-temperature display part including a thermochromic layer, a thermal conductive layer, and a protective layer arranged on a lower surface of a circular cover body 310.

The cover body 310 may have a circular shape with a diameter larger than the maximum diameter of a cooking container that may be placed on the crater. The cover body 310 may be made of transparent or translucent silicone rubber material, as in the previous embodiments.

The high-temperature display part arranged on the lower surface of the cover body 310 may be formed, similar to the high-temperature display part in the embodiment described with reference to FIGS. 1 to 3, by sequentially stacking a thermochromic layer 320 including a thermochromic pigment, which is a thermochromic material, a thermal conductive layer including metal powder, and a protective layer on the lower surface of the cover body 310 in a printing manner. The specific configurations of the thermochromic layer 320, the thermal conductive layer, and the protective layer are the same as the configurations in the embodiment of FIGS. 1 to 3, and therefore redundant descriptions thereof will not be given again.

However, the thermochromic layer 320 of the high-temperature display part in the cover 300 of FIG. 8 may be characterized in view of having a ring shape surrounding the outermost portion of the cover body 310 outside the maximum diameter of the cooking container. For reference, in FIG. 8, the thermochromic pigment of the thermochromic layer 320 is illustrated as having changed to a second color for easy understanding.

A pair of handles 360 may be attached to opposite sides of the outer periphery of the cover body 310. The pair of handles 360 may be formed integrally with the cover body 310 using the same material as the cover body 310. The corresponding handle 360 may have an inverted “U” shaped cross-section and may be formed so that its upper surface is positioned higher than the plane of the cover body 310.

In some embodiments, a soup overflow suppression bump 370 may be provided along the outer periphery of the cover body 310. The soup overflow suppression bump 370 may extend upward from the outer periphery of the cover body 310 to a predetermined height. Accordingly, the soup overflow suppression bump 370 may suppress soup from running over the cooking container 10 placed on the cover 300 during cooking, i.e., from overflowing the cooking container 10 onto the top plate of the inductive heating cooker.

A heat transfer pin 350 may be arranged on the center of the cover body 310. When the crater 120 of the top plate 106 of the inductive heating cooker 100 is covered with the cover 300 of the embodiment of FIG. 8 and the cooking container 10 is placed on the cover 300, an upper end of the heat transfer pin 350 may come into contact with a lower surface of the cooking container 10 and a lower end of the heat transfer pin 350 may come into contact with the top plate 106 of the inductive heating cooker 100 at a position adjacent to a temperature sensor below the top plate 106.

The heat transfer pin 350 may be made of non-magnetic metal, for example, copper or aluminum, which has high thermal conductivity but is not inductively heated by the working coil 110, and may have a cross-sectional shape, for example, a circular, square, or cross-shaped cross-sectional shape.

In an embodiment, the center of the cover and the center of the crater may be slightly misaligned when the cover 300 is placed on the crater. Even in this instance, to enable the temperature sensor 130 of the inductive heating cooker 100 to accurately detect the temperature of the cooking container, the cross-section of the heat transfer pin 350 parallel to the plane of the cover body 310 may be formed to be larger than the cross-section of the temperature sensor 130.

The cover 300 illustrated in FIG. 8 may be formed in a circular shape to correspond to the shape of a typical cooking container 10. However, the cover 300 may also be formed in a shape suitable for use of a cooking container having a shape other than a circular shape, such as an oval, square, or rectangular shape.

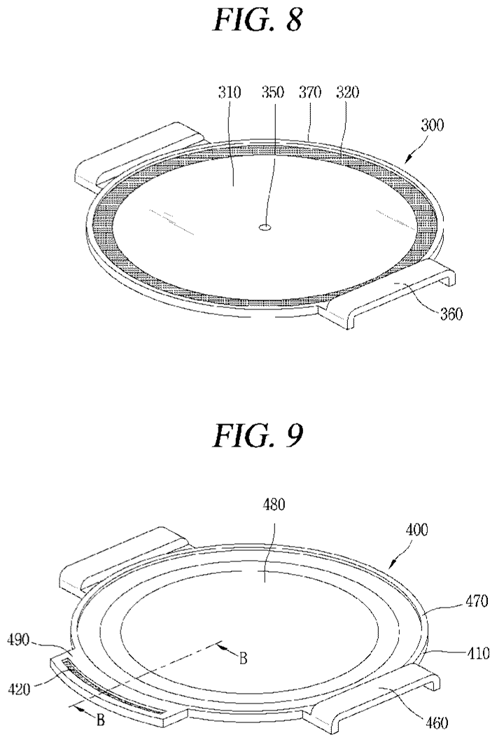

A cover 400 according to still another embodiment will be described with reference to FIGS. 9 to 11. The cover 400 illustrated in FIGS. 9 to 11 may be a heating cover that enables cooking using a cooking container made of non-magnetic material in the inductive heating cooker 100.

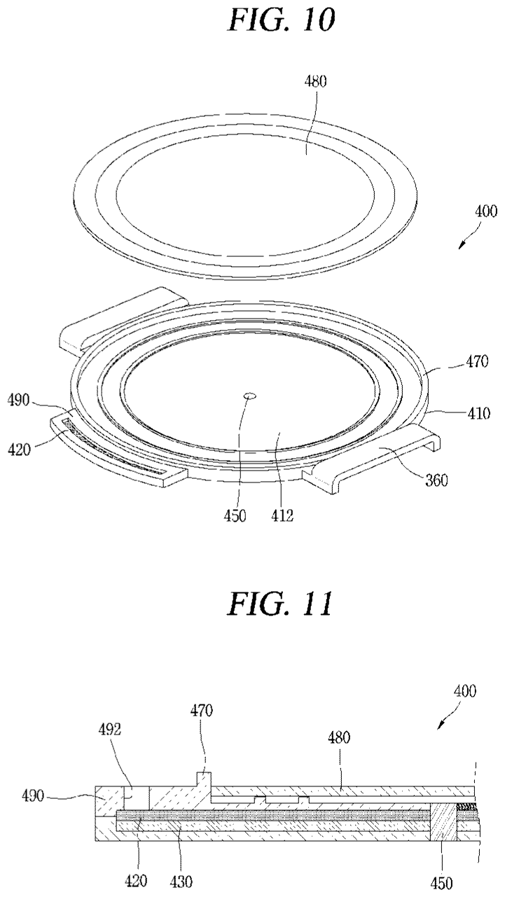

FIG. 9 is a perspective view of the heating cover 400. FIG. 10 is an exploded perspective view of a cover body and a heating plate. FIG. 11 is a cross-sectional view taken along line B-B of FIG. 9.

The heating cover 400 of FIG. 9 may be placed on the top plate 106 of the inductive heating cooker 100 to cover one crater 120 of the inductive heating cooker 100, like the protective cover 300 of FIG. 8.

The cover 400 of FIG. 9 may basically have the same configuration as the cover 300 of FIG. 8, but may further include a heating plate 480 made of magnetic material.

Referring to FIGS. 9 to 11, the heating cover 400 according to an embodiment may include a cover body 410 formed in a circular shape, a high-temperature display part arranged on a lower surface of the cover body 410, and a heating plate 480 placed on an upper surface of the cover body 410.

The cover body 410 may have a circular shape with a diameter equal to or larger than the maximum diameter of a cooking container that may be placed on the crater. The cover body 410 may be made of silicone rubber material, similar to the cover bodies 210, 210′, 210″, and 310 of the protective covers 200, 200′, 200″, and 300 described in the previous embodiments, and may be formed to be transparent, translucent, or opaque, for example.

The high-temperature display part may be formed, like the high-temperature display part in the embodiment described with reference to FIGS. 1 to 3, by sequentially stacking a thermochromic layer 420 including a thermochromic pigment, as a thermochromic material, a thermal conductive layer including metal powder, and a protective layer 440 on the lower surface of the cover body 410 in a printing manner. The specific configurations of the thermochromic layer 420, the thermal conductive layer 430, and the protective layer 440 are the same as the configurations in the embodiment of FIGS. 1 to 3, and therefore will not be described again.

However, in the cover 400 of FIG. 9, the thermochromic layer 420 may be formed on a display panel 490 of the cover body 410, which will be described later. For reference, in FIG. 9, the thermochromic pigment of the thermochromic layer 420 is illustrated as having changed to a second color for easy understanding.

A pair of handles 460 may be attached to opposite sides of the outer periphery of the cover body 410, and an overflow suppression bump 470 having a ring shape may be formed along the outer periphery of the cover body 410. In addition, a heat transfer pin 450 may be arranged on the center of the cover body 410. The configurations of the pair of handles 460, the soup overflow suppression bump 470, and the heat transfer pin 450 may be the same as the configurations of the pair of handles 360, the soup overflow suppression bump 370, and the heat transfer pin 350 of the cover 300 of FIG. 8, and therefore will not be described again.

A display panel 490 may be arranged on one side of the outer periphery of the cover body 410, for example, between the pair of handles 460. The display panel 490 may have a certain width and extend in an arcuate shape along the outer periphery of the cover body 410. A display groove 492 may be formed in an arcuate shape, which is narrow and long, in an upper surface of the display panel 490. The thermochromic layer 420 may be exposed to be visible from the outside through the display groove 492.

Therefore, the thermochromic layer 420 may be exposed to the outside from a lower surface of the display panel 490 located on the outside of the cover body 410, and thus may extend from the center of the cover body 410 to the display panel 490, as illustrated in FIG. 11.

In some embodiments, when the cover body 410 is made of transparent or translucent material, the color change of the thermochromic layer 420 may be confirmed from the outside even without forming the display groove 492 in the display panel 490.

In another example not illustrated, the cover body 410 may not include the display panel 490, and at least one of the pair of handles 460 may replace the role of the display panel 490.

A circular heating plate 480 may be arranged on the upper surface of the cover body 410. The heating plate 480 may be a circular plate made of magnetic material such as an iron plate, and a cooking container 10 made of non-magnetic material, such as ceramic, may be arranged on the heating plate 480 made of the magnetic material.

Cooking may be performed using the cooking container 10 made of the non-magnetic material on the inductive heating cooker 100 by inductively heating the heating plate 480 by the working coil 110 and transferring heat to the cooking container 10 placed on the heating plate 480.

A receiving groove 412 having the same diameter as the diameter of the heating plate 480 may be formed on the upper surface of the cover body 410, and the heating plate 480 may be received in the receiving groove 412. The heating plate 480 may be reliably supported, without moving on the cover body 410, by being received in the receiving groove 412.

Like the cover 300 of FIG. 8, the cover 400 of FIGS. 9 to 11 may also be formed in a non-circular shape, such as an oval, square, or rectangular shape.

The cover 400 having the configuration according to the embodiment of FIGS. 9 to 11 may be placed on any one of the craters 120a, 120b, and 120c of the top plate 106 of the inductive heating cooker 100, and the cooking container made of the non-magnetic material may be placed on the heating plate 480 of the cover 400.

During cooking, the heating plate 480 made of the magnetic material may be inductively heated by a magnetic field generated by the operation of the working coil 110. Cooking may be performed using the cooking container 10 made of the non-magnetic material on the inductive heating cooker 100 by transferring heat generated from the inductively-heated heating plate 480 to the cooking container 10 on the heating plate 480.

The heat generated from the heating plate 480 may be transferred not only to the cooking container but also to the cover body 410 below the heating plate 480, and may reach up to the thermochromic layer 420 of the display panel 490 through the thermal conductive layer 430.

When the temperature of the thermochromic layer 420 exceeds a predetermined temperature (e.g., approximately 40° C.), the thermochromic pigment of the thermochromic layer 420 may change from a first color, which is transparent, to a second color, which is colored, for example, red, and the user may easily visually recognize the risk of burns through the color change of the thermochromic layer 420 of the display panel 490.

In an alternative embodiment, even in the case of a heating cover, as illustrated in the example described with reference to FIG. 6, a thermochromic pigment, which is a thermochromic material, and metal powder with high thermal conductivity may be mixed with a silicone rubber raw material and integrally molded together with the cover body, instead of printing the thermochromic layer and the thermal conductive layer on the lower surface of the cover body. In this instance, the color of the entire cover body may change according to the temperature change of the heating plate, which may facilitate the user's recognition of the risk of burns. Also, the process of printing the thermochromic layer and the thermal conductive layer may be omitted, thereby simplifying the manufacturing process of the cover and reducing processing steps.

As in the case of the cover described above, the overheating suppression function of the inductive heating cooker may be performed by detecting the temperature of the thermal conductive layer and estimating the temperature of the heating plate, without using the heat transfer pin.

A cover for an inductive heating cooker according to the disclosure may visually inform a user of whether the cover is at a high temperature, which may cause the user's burn, by using a thermochromic material that changes color in response to temperature, thereby protecting the user from thermal burns due to high temperature during cooking or residual heat after cooking.

The cover according to the disclosure may visually inform the user of whether the cover is at a high temperature with a simple and inexpensive structure, without the complexity of arranging various components for temperature detection, communication, and charging into the cover, as in the related art cover, by printing on a cover body a thermochromic material that changes color in response to temperature.

The cover for the inductive heating cooker according to the disclosure may have an advantage of allowing the inductive heating cooker to accurately detect the temperature of a cooking container during cooking by employing a heat transfer pin that penetrates the cover vertically, even when the cover is in use.

An inductive heating cooker according to the disclosure may achieve the above-described effects obtained by the cover by including the cover having the configuration described above.

The cover 200, 200′, 200″, 300, 400 for the inductive heating cooker described above may not be limited to the configurations and methods of the embodiments described above, but the embodiments may be configured by selective combination of part or all of the embodiments to implement various modifications.

It will be apparent to those skilled in the art that the disclosure may be embodied in other specific forms without departing from the spirit or essential characteristics thereof. Therefore, it should also be understood that the above-described embodiments are not limited by any of the details of the foregoing description, unless otherwise specified, but rather should be construed broadly within its scope as defined in the appended claims, Therefore, all changes and modifications that fall within the metes and bounds of the claims, or equivalents of such metes and bounds are therefore intended to be embraced by the appended claims.

What is claimed is:

1. A cover for an inductive heating cooker comprising a top plate provided with at least one crater, on which a cooking container is placed, and a working coil arranged on one side of each of the at least one crater of the top plate to inductively heat the cooking container, the cover comprising:
a cover body interposed between the at least one crater of the top plate of the inductive heating cooker and the cooking container; and
a high-temperature display part comprising a thermochromic layer made of a thermochromic material and arranged on one side of the cover body, the thermochromic layer changing a color thereof to a first color below a predetermined temperature and to a second color, different from the first color, at at least the predetermined temperature.

2. The cover of claim 1, wherein the thermochromic layer of the high-temperature display part is arranged on a lower surface of the cover body, and
the cover body is made of silicone rubber material and is transparent or translucent, or comprises a display groove which externally exposes at least a portion of the thermochromic layer.

3. The cover of claim 2, wherein the at least the portion of the thermochromic layer of the high-temperature display part is located outside a maximum diameter of the cooking container to be placed on the at least one crater.

4. The cover of claim 3, wherein the high-temperature display part further comprises a thermal conductive layer configured to transfer heat generated from the cooking container to the thermochromic layer.

5. The cover of claim 4, wherein the thermal conductive layer is made of non-magnetic metal material comprising copper or aluminum.

6. The cover of claim 5, wherein the thermochromic layer is formed by printing the thermochromic material on the lower surface of the cover body, and the thermal conductive layer is formed by printing non-magnetic metal powder on the lower surface of the cover body.

7. The cover of claim 6, wherein the high-temperature display part further comprises a protective layer covering the lower surface of the cover body.

8. The cover of claim 1, wherein the cover body is made of transparent or translucent silicone rubber material, and
the high-temperature display part is formed by mixing the thermochromic material and non-magnetic metal powder with a raw material of the cover body and integrally molding the mixture with the cover body.

9. The cover of claim 1, wherein the cover body comprises a heat transfer pin vertically penetrating the cover body at a portion corresponding to a center of each of the at least one crater.

10. The cover of claim 1, wherein the thermochromic material is a thermochromic pigment.

11. The cover of claim 1, wherein the predetermined temperature ranges from 40°C. to 60°C.

12. The cover of claim 1, wherein the first color is transparent and the second color is colored, or both the first color and the second color are colored.

13. The cover of claim 1, wherein the cover body is configured to cover the entire top plate of the inductive heating cooker, and
the high-temperature display part is arranged on a portion corresponding to each of the at least one crater of the cover body.

14. The cover of claim 1, wherein the cover body is formed in a circular shape with a diameter larger than the maximum diameter of the cooking container to be placed on the at least one crater.

15. The cover of claim 14, wherein the thermochromic layer of the high-temperature display part is formed in a circular or arcuate shape along an outer periphery of the cover body.

16. The cover of claim 14, wherein the cover body further comprises a soup overflow suppression bump formed in a ring shape and extending upward from an outer periphery of the cover body.

17. The cover of claim 14, wherein the cover body comprises a pair of handles extending from opposite ends on an outer periphery of the cover body to a radial outside of the cover body.

18. The cover of claim 14, wherein the cover body comprises a display panel extending from one side on an outer periphery of the cover body to a radial outside of the cover body, and
the thermochromic layer of the high-temperature display part is formed on the display panel.

19. The cover of claim 14, further comprising a heating plate made of magnetic material and arranged on the cover body.

20. An inductive heating cooker comprising:
a top plate comprising at least one crater on which a cooking container is placed;
a working coil arranged on one side of each of the at least one crater of the top plate to inductively heat the cooking container; and
the cover according to claim 1 interposed between the at least one crater of the top plate and the cooking container.
